(19) United States
(12) Patent Application Publication
(10) Pub. No.: US 2008/0011594 A1
(43) Pub. Date: Jan. 17, 2008

(54) Switching Contact Arrangement

(76) Inventors: Erhard Deylitz, Berlin (DE); Ludvik Godesa, Berlin (DE); Jurgen Heydendorf, Hennigsdorf (DE); Ralph Hohenberger, Brieselang (DE); Sezai Turkmen, Berlin (DE)

Correspondence Address: HARNESS, DICKEY & PIERCE, P.L.C., P.O.BOX 8910, RESTON, VA, 20195, US

(21) Appl. No.: 11/587,009

(22) PCT Filed: Apr. 22, 2005
(86) PCT No.: PCT/DE05/00770

§ 371 Date: Aug. 14, 2007

(30) Foreign Application Priority Data
Apr. 22, 2004 (DE) 10 2004 020 654.6

(51) Int. Cl. H01H 1/22

(52) U.S. Cl. 200/244; 200/508

(57) ABSTRACT

A switch contact arrangement including a contact support is disclosed, including a contact support, at least two switch contacts, and at least one spacer. The switch contacts are pivotally mounted on the contact support while being respectively provided with at least one associated terminal lead that encompasses a flexible section. In order to reduce the driving forces required for the switching movements of the switch contacts, the at least one spacer engages between the flexible sections of adjacent switch contacts.

### PRIORITY STATEMENT

This application is the national phase under 35 U.S.C. §371 of PCT International Application No. PCT/DE2005/000770 which has an International filing date of Apr. 22, 2005, which designated the United States of America and which claims priority on German Patent Application number 10 2004 020 654.6 filed Apr. 22, 2004, the entire contents of which are hereby incorporated herein by reference.

### FIELD

The invention is generally in the field of electrical switches and generally relates to a switching contact arrangement. For example, it may relate to one which has a contact carrier, at least two switching contacts and at least one distancing piece and in the case of which the switching contacts are mounted such that they can pivot on the contact carrier and are each provided with at least one associated connecting conductor having a flexible section.

### BACKGROUND

In known switching contact arrangements, at least one distancing piece is provided which is arranged between adjacent ones of the switching contacts in order to keep the switching contacts at a predetermined distance and therefore to avoid fanning out (tipping) of the switching contacts owing to the mutual influence of the switching contacts mounted on a contact carrier or owing to the mutual influence of the switching contacts mounted on adjacent contact carriers (DE 100 48 660 A1, EP 0 727 805 A2, EP 0 955 658 A2). Owing to the improvement in the frictional relationships achieved in the process, the level of the drive forces required for the switching movements of the switching contacts is reduced.

### SUMMARY

At least one embodiment of the invention includes a switching contact arrangement for reducing the level of required drive forces.

In at least one embodiment of the invention, the at least one distancing piece engages between the flexible sections of adjacent connecting conductors. The at least one distancing piece serves the purpose of keeping the connecting conductors at a distance from one another and absorbing the electrodynamic forces acting between the connecting conductors. As a result, excessive deflection of the connecting conductors at right angles to the pivot axis to the switching contacts and therefore, in addition to the fanning open (tipping), also bending of the switching contacts connected to the connecting conductors are avoided, in particular at high short-circuit currents. This measure contributes to the further improvement in the frictional relationships within the switching contact arrangement and in particular to the avoidance of self-locking of the switching contacts.

In one example refinement of an embodiment of the novel switching contact arrangement, provision is made for the at least one distancing piece to be an integral part of the contact carrier. In such a refinement, the function according to an embodiment of the invention can be realized directly when the contact carrier is produced without any additional manufacturing and fitting complexity. For this purpose, the contact carrier may have, in the region of the flexible sections of the connecting conductors, a wall, which extends transversely with respect to the pivot axis of the switching contacts and to which the at least one distancing piece is fitted.

In another refinement of an embodiment of the novel switching contact arrangement provision is made for the at least one distancing piece to be part of a separate spacer. Such a refinement has the advantage that the switching contact arrangement can be equipped in a simple manner with the desired number and position of distancing pieces owing to the selection of a corresponding spacer. In this case, the separate spacer can advantageously be fixed to the contact carrier. In this refinement, the contact carrier can also have, in the region of the flexible sections of the connecting conductors, a wall, which extends transversely with respect to the pivot axis of the switching contacts, for the purpose of fitting the separate spacer.

### BRIEF DESCRIPTION OF THE DRAWINGS

Two example embodiments of the novel switching contact arrangement are illustrated in FIGS. 1 to 4, in which: FIG. 1 shows a schematic illustration of an electrical switch having a switching contact arrangement,

FIGS. 2 and 3 show a first example embodiment of the novel switching contact arrangement, and

FIG. 4 shows a second example embodiment of the novel switching contact arrangement.

### DETAILED DESCRIPTION OF THE EXAMPLE EMBODIMENTS

FIG. 1 shows an electrical switch 1 in the form of a low-voltage power circuit breaker, which has a switching contact system, an arc-quenching device 2 associated with the switching contact system and a switching pole housing formed from two housing shells 3 and 4. The switching pole housing in this case forms an integrated switching chamber 5 for the purpose of accommodating the switching contact system and an integrated quenching chamber 6, which is open towards the switching chamber 5, for the purpose of accommodating the arc-quenching device 2.

The switching contact system comprises a stationary switching contact arrangement 7 and a movable switching contact arrangement 8. Two connection rails 9a, 9b associated with the switching contact arrangements protrude into the switching chamber 5. The movable switching contact arrangement 8 in this case has a pivotable contact carrier 10 and a plurality of movable switching contacts 11 in the form of contact levers. The movable switching contacts 11 are supported, under prestress, in a resilient manner on the contact carrier 10 such that they can pivot parallel to one another about a bearing bolt 12 and by way of in each case two contact force springs 13.

The movable switching contact arrangement 8 is coupled in a known manner to a switching shaft 15 via a lever arrangement 14 indicated merely schematically in FIG. 1. The switching shaft 15 at the same time is used for driving further switching contact systems, which are not illustrated in any more detail, are arranged parallel to the switching contact system shown and each have a further arc-quenching device (likewise not illustrated) associated with them.

The switching shaft 15 can be moved, via a drive apparatus 16, out of an off position, in which the switching contact systems are open, into an on position, in which the switching contact systems are closed. When the switching shaft 15 is moved into its on position, the contact force springs 13 are stressed further.

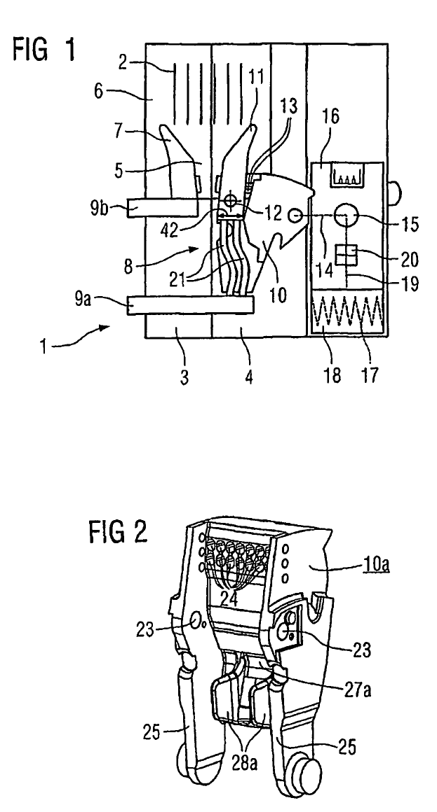

The drive apparatus 16 has a drive 18, which is provided with a storage spring 17, a drive train 19, which couples the drive 18 to the switching shaft 15, and a switching mechanism 20. Each of the switching contacts is connected to first ends of two connecting conductors 21, which have a flexible section 22 (cf. FIGS. 2 to 4), at that end of the lever which faces away from the quenching chamber 6, in order to ensure the pivoting movement of the switching contacts 11. The second ends of the connecting conductors 21 are connected to a first one 9a of the two connection rails, which protrudes into the lower region of the switching chamber 5. The second one 9b of the two connection rails which protrudes into the upper region of the switching chamber 5 is connected to the stationary switching contact arrangement 7.

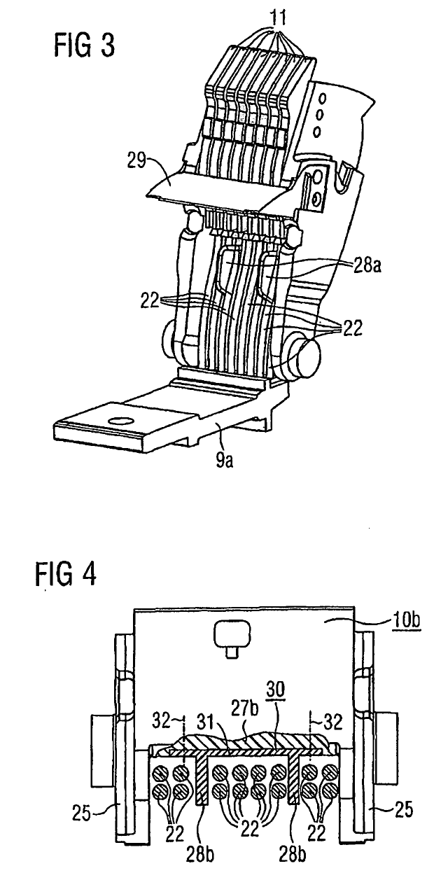

As shown in FIGS. 2 and 4, the pivotable contact carrier 10a; 10b is produced integrally as a multifunctional part from plastic, as is already known from the document EP 1 218 898 B1. In this case, it is in particular provided with accommodating openings 23 for the bearing bolts 12 which pass through the switching contacts 11, accommodating pockets 24 for the contact force springs 13, lateral bearing arms 25 for pivotably bearing the contact carrier 10a; 10b at bearing points in the switching chamber 5 and bearing means for a hinge pin for coupling the contact carrier 10a; 10b to the lever arrangement 14, which are provided on the rear side (not visible in FIG. 2 and 4) of the contact carrier (10a; 10b). Furthermore, the contact carrier 10a; 10b has a wall 27a; 27b which extends transversely with respect to the pivot axis 26 of the switching contacts 11.

As shown in FIGS. 2 and 3, the wall 27a is provided with two distancing pieces 28a in the form of ribs, which extend transversely with respect to said wall and, as the wall 27a itself, are an integral part of the contact carrier 10a produced as a multifunctional part from plastic.

As shown in FIG. 3, the two distancing pieces 28a each engage between the flexible sections 22 of adjacent ones of the connecting conductors.

In addition to the distancing pieces 28a, which are associated with the flexible sections 22 of the connecting conductors, further distancing pieces associated with the switching contacts 11 are provided which are formed on a first spacer 29 and engage between adjacent ones of the switching contacts 11. Various embodiments of spacers associated with the switching contacts are known, as mentioned at the outset, for example from documents EP 0 727 805 A2, EP 0 955 658 A2 and DE 100 48 660 A1.

As shown in FIG. 4, the distancing pieces 28b associated with the flexible sections 22 of the connecting conductors are also part of a separate second spacer 30. This separate second spacer 30 has a web 31, from which the distancing pieces 28b protrude at right angles in the form of ribs. This separate second spacer 30 can be cast into the wall 27b during production of the contact carrier 10b for example from a duroplastic or fixed to the wall 27b later, once the contact carrier 10b has been produced, in a suitable manner—for example by way of screw connections 32.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A switching contact arrangement, comprising:
a contact carrier;
at least two switching contacts, pivotably mounted on the contact carrier each at least two switching contacts including at least one associated connecting conductor having a flexible section; and
at least one distancing piece characterized in that the at least one distancing piece (28a; 28b) engages engaging between flexible sections of adjacent connecting conductors.

2. The switching contact arrangement as claimed in claim 1, wherein the at least one distancing piece is an integral part of the contact carrier.

3. The switching contact arrangement as claimed in claim 1, wherein the at least one distancing piece is part of a separate spacer.

4. The switching contact arrangement as claimed in claim 3, wherein the separate spacer is fixed to the contact carrier.

5. The switching contact arrangement as claimed in claims 1, wherein the contact carrier includes, in the region of the flexible sections of the connecting conductors, a wall, extending transversely with respect to the pivot axis of the switching contacts and to which the at least one distancing piece is fitted.

6. The switching contact arrangement as claimed in claims 3, wherein the contact carrier includes, in the region of the flexible sections of the connecting conductor, a wall, extending transversely with respect to the pivot axis of the switching contacts and to which the separate spacer, provided with the at least one distancing piece, is fitted.

7. The switching contact arrangement as claimed in claim 1, wherein the contact carrier includes, in the region of the flexible sections of the connecting conductors, a wall, extending transversely with respect to the pivot axis of the switching contacts and to which the at least one distancing piece is fitted.

8. The switching contact arrangement as claimed in claim 4, wherein the contact carrier includes, in the region of the flexible sections of the connecting conductors, a wall, extending transversely with respect to the pivot axis of the switching contacts and to which the separate spacer, provided with the at least one distancing piece, is fitted.
